(19) United States
(12) Patent Application Publication
(10) Pub. No.: US 2017/0091700 A1
(43) Pub. Date: Mar. 30, 2017

(54) VENDING MACHINE BASED PROCURE-TO-PAY SYSTEM

(71) Applicants: Biju Mohan, Westfield, NJ (US); Neil Makhija, Westfield, NJ (US)

(72) Inventors: Biju Mohan, Westfield, NJ (US); Neil Makhija, Westfield, NJ (US)

(73) Assignee: Global eProcure, Clark, NJ (US)

(21) Appl. No.: 14/864,431

(22) Filed: Sep. 24, 2015

(51) Int. Cl. G06Q 10/08; G06Q 20/18

(52) U.S. Cl. CPC G06Q 10/087; G06Q 20/18

(57) ABSTRACT

Disclosed are methods of purchasing an item from a vending machine. In one example method after an item is purchased from a vending machine, the vending machine determines how many items are left in the vending machine. If the items are less than a predetermined value, the vending machine sends an alert to a cloud based management system. In this nonlimiting example embodiment, the cloud based management system may send a purchase order to a supplier in response to the alert.

### BACKGROUND

1. Field

Example embodiments relate to a vending machine based procure-to-pay system.

2. Description of the Prior Art

Vending machines have been used for decades for soda, water and snacks. For the past decade or so the use of vending machines has been increasing to include other items such as electronics, toys, spare parts, and office supplies (among many things).

### SUMMARY

In this application, at least one example of an automatic cloud based vending machine is disclosed. In at least one example, the automatic vending machine operates in response to a card inserted by a user. The card contains identification information which may be used to access data stored in a memory device regarding the amount of money the user has credited to his or her account. If the account balance exceeds the purchase price of a desired item, the item is supplied to the user and the amount of the purchase is deducted from his or her account. A user may increase his or her account balance at any time by inserting money into the machine. In at least one embodiment, security may be maintained through the use of a security code which the user may input into the machine after the card is inserted.

Example embodiments of the current invention combine the cloud based vending machines with existing cloud based procure-to-pay systems. For example, conventional smart cloud based platforms exist that automate a process of buying via cloud computing with mobile interface. This single platform may allow users to keep track of all buying processes, including contracting and compliance.

The systems according to example embodiments are particularly useful for buying of low value but high frequency items such as lab supplies, Material, Repair and Operational (MRO) items. In at least one example embodiment, an employee swipes his/her employee card into a vending machine, selects the items (SKUs) needed, receives it from the machine and consumes the SKUs. The order from the vending machine via the cloud is transmitted to a cloud based procurement system. The procurement system updates the inventory, keep tracks of employee spending, and the inventory. When the inventory of any SKU falls below a specified level an order with the Original manufacturer is placed automatically via the cloud based procure to pay system. The system bypasses the process of creating requisition, approval, conversion to order and individual invoicing form the vendors.

One feature of at least one example of the invention is a single comprehensive item master. This item master keeps track of all items that are contracted, purchased, inventoried, stocked, etc. In the new system, this item master is expanded to include items in the vending machine. Hence the item master can keep track of inventory in the system and sends the signal to the supplier once the items fall below a pre specified threshold of inventory. The category based approval may be mapped with the employee electronic identification cards.

When employee swaps the employee card through the vending machine, the machine verifies the purchasing authority or rules for that employee from the approval table and instruct the employee about the next steps. If employee is authorized to buy that product the normal buying process continues. However, if the employee is not authorized to buy then an appropriate message is given to the users.

There are several benefits to the users as well as suppliers because of the enhanced vending machine process described above. For example, a user can check the stock level a in vending machine from his hand-held device, thereby avoiding situations where he/she has to return empty-handed from the physical store-room. As another example, the entire SKU issuing process time is faster, as the user does not have go to the physical stock room and search for the SKU. As yet another example, no manual transactional activity required including raising purchase requests, stock updates, generating POs etc as the POs, stock updates etc. are handled automatically by the machine based on preset re-order point and re-order quantities defined in the system. As yet another example, example embodiments promote an accurate tracking of physical inventory as there is no human intervention thus reducing chances of loss due to breakage and pilferage. As yet another example, where applicable, the expiry dates of SKUs (in the case of perishables) can be used to generate replenishment POs. As for the suppliers, the suppliers will have online tracking of stock levels in the vending machine. The supplier will have faster and accurate receipt of POs—eliminating delayed shipments and inaccurate POs. The process also supports vendor managed inventory (VMI) programs put in place by the supplier with minimal on-site manual involvement—as the entire process is automated through the vending machine. Finally, the invention gives more information to supplier about ordering patterns at the customer site, for example, number of orders, time of orders, people who get SKUs from vending machines.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a system in accordance with example embodiments;

FIG. 2 is a view of a management system in accordance with example embodiments;

FIG. 3 is a view of a vending machine in accordance with example embodiments;

FIG. 4 is a view of a method in accordance with example embodiments; and

FIG. 5 is a view of a method in accordance with example embodiments.

### DETAILED DESCRIPTION

Example embodiments will now be described more fully with reference to the accompanying drawings, in which example embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers, and/or sections, these elements, components, regions, layers, and/or sections should not be limited by these terms. These terms are only used to distinguish one element, component, region, layer, and/or section from another elements, component, region, layer, and/or section. Thus, a first element component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to plan views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures exemplify specific shapes or regions of elements, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to a vending machine based procure-to-pay system.

FIG. 1 is a view of a system 1000 in accordance with example embodiments. In example embodiments, the system 1000 may include a management system 100, a user interface 200, a vending machine 300, and a supplier 400. In example embodiments the management system 100 may be a part of a cloud based procurement system and may include at least one central processing unit 110 and at least one electronic database 120. In example embodiments, the management system 100 may keep track of items in the vending machine 300 and may keep track of contracting, purchasing, inventorying, and stocking of the vending machine 300. The management system 100 may perform other tasks associated with a procurement system. For example, the management system 100 may be further configured to conduct spend analysis, inventory management, purchasing behavior data analytics, process audit and pricing audit. The management system 100 may also provide data to suppliers and provide suppliers with up-to-date information regarding items they supply to the vending machine 300.

In example embodiments the management system 100 may be configured to send and receive data to at least one of the user interface 200, the vending machine 300, and the supplier 400. For example, the management system 100 may be part of a computer network and the user interface 200, the vending machine 300, and the supplier 400 may be connected to the management system 100 through the computer network. In addition, communication between the user interface 200 and the management system 100, between the vending machine 300 and the management system 100, and between the management system 100 and the supplier 400 may be over a wire or may be wireless.

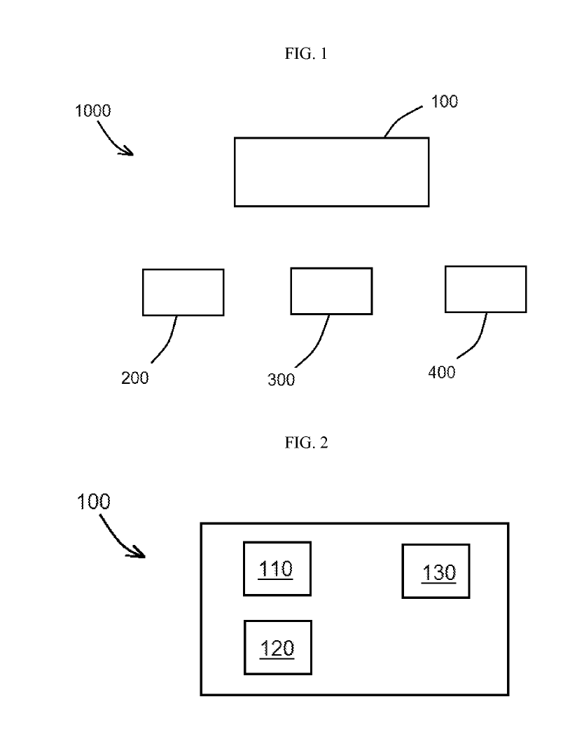

FIG. 2 is a view of an example management system 100. The management system 100 may be embodied as a computer having a computer readable medium embedded with instructions to control the computer. The management system 100, for example, may include the central processing unit 110 and a memory unit 130 having the instructions encoded thereon. The instructions may control the central processing unit 110 to perform various operations. For example, the instructions may control the processor 110 to manage, store, and update data in at least one electronic database 120. The data, for example, may be associated with items in the vending machine 300 and/or users who use the vending machine 300. For example, the vending machine 300 may enclose various items (for example, soda, water, snacks, medication, lab supplies, materials, and repair and operations items) and the vending machine 300 may send purchase information to the management system 100. The management system 100 may keep track of the items purchased thus having an up-to-date list of items in the vending machine 300. In at least one example embodiment, at least one electronic database 120 may also store data related to a minimum number of items that may be in a vending machine 300 and the CPU 110 may use this data to determine whether or not a purchase order should be sent from the management system 100 to the supplier 400. For example, if the vending machine 300 includes fifty cans of soda and it is determined that a purchase order be sent to the supplier 400 in the event the number of cans of soda fall below a predetermined number stored in the at least one electronic database 120 (for example fifty), then the CPU 110 may compare the number of actual cans of soda in the vending machine 300 to the predetermined number to determine whether a purchase order for soda should be sent to the supplier 400.

In example embodiments the management system 100 may perform additional tasks. For example, the management system 100 may receive data regarding one or more purchasers of items from the vending machine 300. The management system 100 may apply analytics to study the behavior of the one or more purchasers which may be used to better predict how to keep the vending machine 300 adequately stocked.

In example embodiments, a list of items in the vending machine 300 may be made available to a user through the user interface 200. Thus, the user may be made aware of items in the vending machine 300 without actually having to physically inspect the vending machine 300.

In example embodiments the user interface 200 may be a computer interface and may take the form of a cell phone, an I-pad, or a personal computer. In example embodiments the user interface 200 may communicate with the management system 100 either by wire or wirelessly. Because such user interfaces are well known in the art a detailed description thereof is omitted for the sake of brevity. In at least one example embodiment the user interface 200 may be used by a person to communicate with the management system 100 to learn of the availability of an item in the vending machine 300.

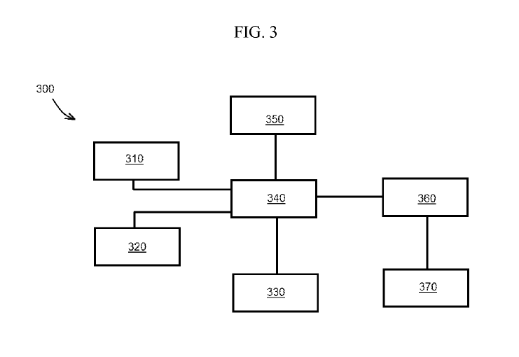

FIG. 3 is a view of an example vending machine 300 in accordance with example embodiments. As shown in FIG. 3, the vending machine 300 may be comprised of various elements. For example, in the nonlimiting example of FIG. 3, the vending machine 300 may be comprised of a card reader 310, an interface panel 320, a memory unit 330, a microprocessor 340, a money receipt device 350, a goods conveying unit 360, and a goods storage unit 370.

In example embodiments, the microprocessor 340 may be connected to card reader 310 as shown in FIG. 3. Thus, in example embodiments, the microprocessor 340 may receive card identifying information as a card is inserted into the card reader 310. In example embodiments, the card reader 310 may be a standard card reading device configured to read information stored on a card. For example, in one nonlimiting example embodiment, the card may include a magnetic strip and the magnetic strip may contain data readable by the card reader 310. In another embodiment a user interface, for example, a cell phone or an I-PAD, may bear a bar code which may be read by a scanner of the vending machine 300. The scanner may provide data and the microprocessor 340 may determine various security levels of the user controlling the user interface and may use this data to allow the user to purchase items from the vending machine 300.

In example embodiments the microprocessor 340 may also be connected to the interface panel 320. The interface panel 320 may include a display panel through which a customer may select items in the vending machine 300. For example, the interface panel 320 may include a touch screen with identifying information identifying an item in the vending machine 300 and a user may select the item by pressing the touch screen. In another embodiment, the interface panel 320 may be a control/display panel provided with selecting switches and display means to indicate information stored in the memory unit 330.

In example embodiments the microprocessor 340 may be connected to card memory unit 330. In example embodiments, the card memory unit 330 may store card identification information corresponding to cards which have been registered by an operator of the vending machine 300. As such, each card holder may have different identification information. Card memory unit 330 may be in communication with microprocessor 340 for receiving card identification information which may be stored together with information relating to the prepaid amount of each card, i.e. a customer's credit balance.

In at least one example embodiment, the memory unit 330 may store additional data, for example, an inventory of the goods housed by the vending machine 300. Furthermore, the vending machine 300 may use this memory unit 330 to determine the number of the particular goods in the vending machine. For example, the vending machine 300 may enclose fifty cans of a first type of soda and fifty cans of a second type of soda and the vending machine 300 may be configured to track the purchases of the sodas and keep an up to date list of the sodas (or other items) in the vending machine 300. The memory unit 330 may also store data related to a minimum number of goods the vending machine 300 stores. For example, an owner of the vending machine may decide at least thirty cans of the first type of soda must be in the vending machine 300 at all times and at least twenty cans of the second type of soda must be stored in the vending machine at all times. If the number of cans of soda fall below their minimum values, the vending machine 300 may send a signal to the management system 100 and the management system 100 may thereafter place a purchase order to the supplier 400 to replenish the vending machine 300.

In example embodiments the microprocessor 340 may further be connected to the goods conveying unit 360 which may be connected to the goods storage unit 370. The goods conveying unit 360 may be responsive to an authorization signal received from microprocessor 340 and may retrieve selected goods from the goods storage unit 370 and supply the good to a customer. Both the goods conveying unit 360 and goods storage unit 370 may comprise known components found in conventional automatic vending machines.

In example embodiments, the microprocessor 340 may also be connected to the money receipt device 350 which may detect an amount of money deposited in the vending machine 300. The amount of money deposited may be stored in memory unit 330 through microprocessor 340 in accordance with each card identification information. Therefore, an amount of money deposited may be stored under the identification information of each card.

In example embodiments a customer who wishes to use the vending machine 300 may obtain a card having identification information (for example, personal identification information) thereon. The customer may insert the card into card reader 310. The customer may then deposit an amount of money, for example one dollar, through the money receipt device 350. The memory unit 330 may store combined information relating to the identification information and the amount of money deposited. Interface 320 may indicate to the customer the amount deposited. Thereafter, the customer may purchase goods from the automatic vending machine 300. The customer may purchase any merchandise stored in the vending machine 300 up to the deposited amount. When a customer inserts the card into the card reader 310, the card reader 310 may read the identification information and retrieve the amount remaining in that account and display this amount to the customer. The customer may then select the desired good and microprocessor 340 may compare the price of the selected good with the amount remaining for that card, and if the amount remaining is more than the purchase price, the microprocessor 340 may generate an operating signal to supply the selected good through the good conveying unit 360 to the customer. Microprocessor 340 may then store the remaining amount of money in memory unit 330. The microprocessor 340 may simply subtract the purchase price from the original amount and may store the remainder for the next transaction. This process may be repeated each time the customer makes a purchase. When the purchase price exceeds the amount stored in memory, the customer may be informed and may add money to the account. In addition to the above operations, the microprocessor 340 may also send a signal to the management system 100. The signal may indicated the type of good that was purchased by the customer so that the management system 100 may have an up-to-date list of items in the vending machine 300. In the event a number of items in the vending machine 300 falls below a predetermined value, the management system 100 may generate and send a purchase order to the supplier 400 so the supplier can properly stock the vending machine 300 with goods.

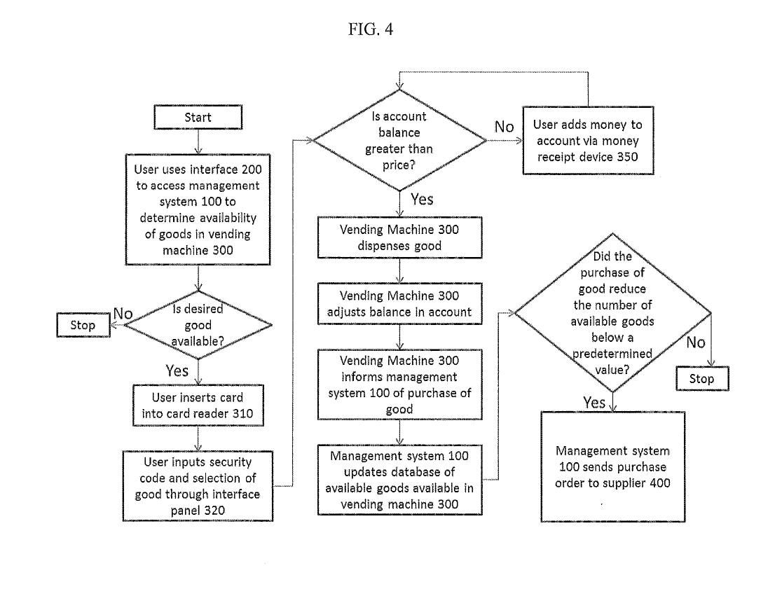

A process of obtaining a good from the vending machine 300 is described with reference to FIG. 4. Initially a customer may use the interface 200 to determine whether a particular good is available in a particular vending machine 300. The interface 200, for example, may wirelessly connect to the management system 100 which may include an up-to-date list of goods available in vending machine 300. Because the management system 100 may include an up-to-date list of goods available in the vending machine 300, the customer may know what items are available in the vending machine 300 without having to physically inspect the vending machine 300. As such, a customer may avoid a wasted trip to the vending machine 300 in the event the vending machine 300 is not carrying a good the customer is interested in buying. In addition, the management system 100 may also indicate the number of a particular item present in the vending machine 300. For example, if the user were interested in buying ten candy bars, the user may know, from the management system 100, how many of the candy bars are in the machine. In the event only eight were present, the user might avoid a trip to the vending machine 300 if the user deems eight is not worth making a trip to the vending machine 300. In the event the user determines a particular good (or number of goods) is present in the vending machine 300, and the user desires to purchase the good (or goods), the user may physically move to the vending machine 300. The user may then insert a card into the card reader 310 and select the desired good. Processor 340 may then determine whether the purchase price is below an amount remaining on the user's account. If it is not, the user may increase user's account by adding money through the money receipt device 350. If the purchase price of the good is below the amount remaining in the account, the conveying unit 360 delivers the selected good to the customer from the goods storage unit 370 and the stored amount in the account is adjusted accordingly. The microprocessor 340 may then send a signal to the management system 100 indicating that a particular good had been purchased and the management system 100 may update its data regarding the number of goods that remain in the vending machine 300. The management system 100 may then determine whether the number of goods of a particular good falls below a predetermined level. In the event the number of goods falls below a predetermined level, the management system 100 may send a purchase order to the supplier 400 and the supplier may restock the vending machine 300. In example embodiments, the operation of determining whether or not a number of goods falls below a predetermined level may be performed by the management system 100. On the other and, in another embodiment this determination may be made by the vending machine 300.

In one nonlimiting example embodiment of the system 1000, the card functions only to identify and extract information from a memory unit 330 leaving the system 1000 prone to dishonest acts by dishonest purchasers who attempt to use counterfeit cards, stolen cards or the like. To avoid this potential pitfall, the microprocessor 340 may be configured to request identifying information, for example, a security code, be entered through the interface 320. The microprocessor 340 may compare the entered information against information stored in the memory unit 330. If the information matches, the user may engage in the above process for obtaining a good from a vending machine.

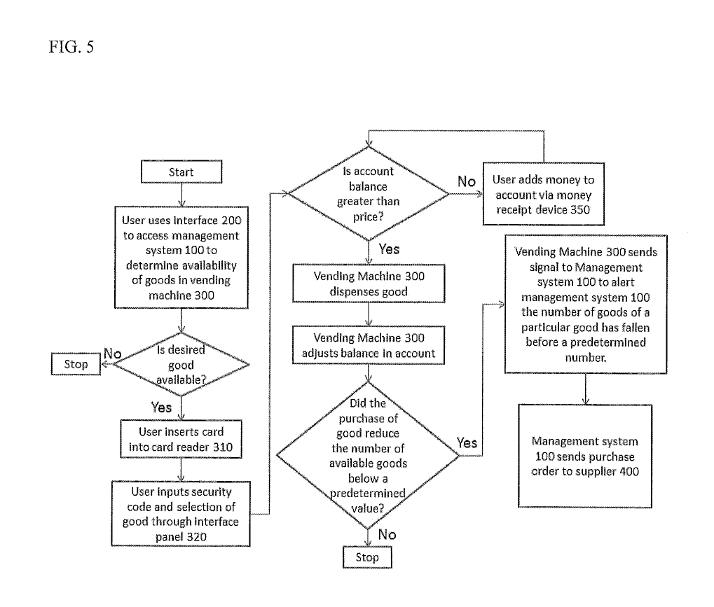

FIG. 5 another process of obtaining a good from the vending machine 300. In FIG. 5, the operations are similar to those of FIG. 4, however, in FIG. 5 once an item is dispensed from the vending machine 300 and the vending machine 300 adjusts the balance of an account, the vending machine 300 may determine whether or not the number of goods of a particular good has fallen below a preset level. If it has, then the vending machine 300 sends a signal to the management system 100 and the management system 100 may send a purchase order to the supplier 400.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the claims.

What is claimed is:

1. A method comprising:
informing a web based management system of a purchase of a good;
using the web based management system to calculate a number of goods in a vending machine;
using the web based management system to determine whether the number of goods in the vending machine is below a preset value; and
using the web based management system to send a purchase order to a supplier in the event the number of goods in the vending machine is below the preset value.

2. The method of claim 1, further comprising:
using an interface to determine whether the good is in the vending machine prior to purchasing the good.

3. The method of claim 1, further comprising:
updating tables managed by the web based management system to keep an up-to-date list of items in the vending machine.

4. The method of claim 3, further comprising:
inserting a card into the vending machine.

5. The method of claim 4, wherein
uploading security information into the vending machine.

6. A method comprising:
using a vending machine to calculate a number of goods in the vending machine;
sending an alert to a web based management system in the event the number of goods in the vending machine is below a preset value; and
using the web based management system to send a purchase order to a supplier.

7. The method of claim 6, further comprising:
using an interface to communicate with web based management system to determine whether the good is in the vending machine prior to purchasing the good.

8. The method of claim 6, further comprising:
updating tables managed by the web based management system to keep an up-to-date list of items in the vending machine.

9. The method of claim 8, further comprising:
inserting a card into the vending machine.

10. The method of claim 9, wherein
uploading security information into the vending machine.

11. A system comprising:
a web based management system configured to keep an up to date list of goods in a vending machine; and
the vending machine, wherein the vending machine is configured to send a signal to the web based management system informing the web based management system of the purchase of a good and the web based management system is configured to send a purchase order to a supplier in the event the number of goods in the vending machine is below the preset value.

12. The system of claim 11, wherein the web based management system is configured to send the up-to-date list of goods to a user interface in response to a request from the user interface.

13. A system comprising:
a vending machine configured to calculate a number of goods in the vending machine and send a signal to a management system when the number of goods is below a preset value; and
the management system configured to receive the signal from the vending machine and place a purchase order with a supplier.

14. The system of claim 13, wherein the web based management system is configured to send a list of goods to a user interface in response to a request from the user interface.
